(19) United States
(12) Patent Application Publication
(10) Pub. No.: US 2019/0100072 A1
(43) Pub. Date: Apr. 4, 2019

(54) SPACE EFFICIENT PANEL AND DEFROST PLENUM

(71) Applicant: FORD GLOBAL TECHNOLOGIES, LLC, Dearborn, MI (US)

(72) Inventors: Steve Michael Kahrs, Canton, MI (US); Michael Murphy McElroy, South Lyon, MI (US); Jennifer A. Herr-Rathke, Plymouth, MI (US); James R. Hurd, III, Northville, MI (US); Jose A. Nava, Plymouth, MI (US)

(21) Appl. No.: 15/720,504

(22) Filed: Sep. 29, 2017

(51) Int. Cl. B60H 1/00

(52) U.S. Cl. CPC B60H 1/0055; B60H 1/00671; B60H 1/00028

(57) ABSTRACT

A panel and defrost plenum includes a manifold section, an air feed section upstream from the manifold section and a branch section downstream from the manifold section. The air feed section delivers an airstream past a HUD package restriction to the manifold section. A related method of routing an airstream past a HUD package restriction is also disclosed.

### TECHNICAL FIELD

This document relates generally to the motor vehicle equipment field and, more particularly, to a new and improved panel and defrost plenum that is space efficient and allows delivery of an airstream past a heads-up display (HUD) package restriction.

### BACKGROUND

A heads-up display (HUD) is a transparent display that projects data or other information onto the windshield of a motor vehicle where it is visible without requiring the driver/operator of the motor vehicle to look away from the forward view utilized to drive the motor vehicle. The automotive industry is currently adopting new generation HUD technology which enhances the user/driver experience.

These new generation HUD units occupy a relatively large space inside the instrument panel of the motor vehicle thereby limiting space available for HVAC system components providing occupant climate comfort. This document relates to a new and improved panel and defrost plenum that is more space efficient and is particularly suited for delivering an airstream past a HUD package restriction while still providing the desired heating and cooling performance at lower noise levels.

### SUMMARY

In accordance with the purposes and benefits described herein, a new and improved panel and defrost plenum is provided. That panel and defrost plenum comprises a manifold section, an air feed section upstream from the manifold section and a branch section downstream from the manifold section. The air feed section functions to deliver an airstream past a HUD package restriction to the manifold section within the relatively limited available space in the instrument panel.

The manifold section may include a displaceable air distribution door. The manifold section may also include a first air discharge port and a second air discharge port. An actuator, connected to the displaceable air distribution door, allows displacement of the air distribution door between different operating positions. Those different operating positions function to direct air to different zones of the motor vehicle in the manner desired by the motor vehicle operator.

The branch section may include a first branch duct extending from the first air discharge port to an outboard panel duct outlet. In addition, the branch section may include a second branch duct extending from the second air discharge port to a windshield defrost duct outlet. Further, the branch section may include a third branch duct extending from the second air discharge port to a side window demist duct outlet.

In one particularly useful embodiment the air feed section includes a single lumen for delivering the airstream to the manifold section. In one or more embodiments of the panel and defrost plenum, an air bleed feature is provided on the displaceable air distribution door. That air bleed feature may be provided toward the middle of the displaceable air distribution door. In another possible embodiment, that air bleed feature is provided along an edge of the displaceable air distribution door opposite a pivot axis of that door.

In accordance with an additional aspect, a method is provided of routing an airstream past a HUD package restriction. That method comprises delivering the airstream in a feed section of a plenum past the HUD package restriction to a manifold section of the plenum and directing the airstream in a branch section of the plenum, downstream of the manifold section, to at least one outlet.

The method may further include the step of providing the manifold section with multiple air discharge ports. Further, the method may include the step of diverting, by a displaceable air distribution door, the airstream to at least one of the air discharge ports.

Still further, the method may include connecting a first air discharge port of the multiple air discharge ports with an outboard panel duct outlet. Further, the method may include the step of connecting a second air discharge port of the multiple air discharge ports with a windshield defrost duct outlet. Still further, the method may include the step of connecting the second air discharge port of the multiple air discharge ports with a side window demist duct outlet.

The method may also include the step of passing the airstream through a single lumen past the HUD package restriction. Further, the method may include the step of directing the airstream into different branch ducts on a downstream side of the HUD package restriction. That downstream side may be outboard of the HUD package restriction and the instrument cluster of the instrument panel located forward of the driver and the steering wheel.

In the following description, there are shown and described several preferred embodiments of the panel and defrost plenum and the method of routing an airstream past a HUD package restriction. As it should be realized, the panel and defrost plenum and method are capable of other, different embodiments and their several details are capable of modification in various, obvious aspects all without departing from the panel and defrost plenum and method as set forth and described in the following claims. Accordingly, the drawings and descriptions should be regarded as illustrative in nature and not as restrictive.

### BRIEF DESCRIPTION OF THE DRAWING FIGURES

The accompanying drawing figures incorporated herein and forming a part of the specification, illustrate several aspects of the panel and defrost plenum and related method of routing an airstream past a HUD package restriction and together with the description serve to explain certain principles thereof.

FIG. 1 is a perspective view of the panel and defrost plenum and a schematic view of the HVAC system and air circulation fan of the HVAC system which delivers conditioned air from the HVAC system to the panel and defrost plenum.

FIG. 2 is an exploded perspective view of the manifold section of the panel and defrost plenum illustrating the two housing sections and the displaceable air distribution door held in the housing formed by those two housing sections.

FIG. 3a is a detailed schematic illustration of the displaceable air distribution door in a first operating position directing 100% of the airstream through a first air discharge port.

FIG. 3b is a view similar to FIG. 3a but illustrating the displaceable air distribution door in a second operative position wherein 100% of the airstream is directed through a second air discharge port.

FIG. 3c is a view similar to FIGS. 3a and 3b but illustrating the displaceable air distribution door in a third operative position wherein a portion of the airstream is delivered through both the first air discharge port and the second air discharge port.

FIG. 4 is a view of an alternative embodiment of the panel and defrost plenum wherein the displaceable air distribution door includes a bleed feature along the distal edge of that door.

FIG. 5 is a schematic illustration of yet another possible embodiment of the panel and defrost plenum wherein the displaceable air distribution door includes a bleed feature in the form of an aperture in the face of the door.

Reference will now be made in detail to the present preferred embodiments of the panel and defrost plenum and the related method of routing an airstream past a HUD package restriction, examples of which are illustrated in the accompanying drawing figures.

### DETAILED DESCRIPTION

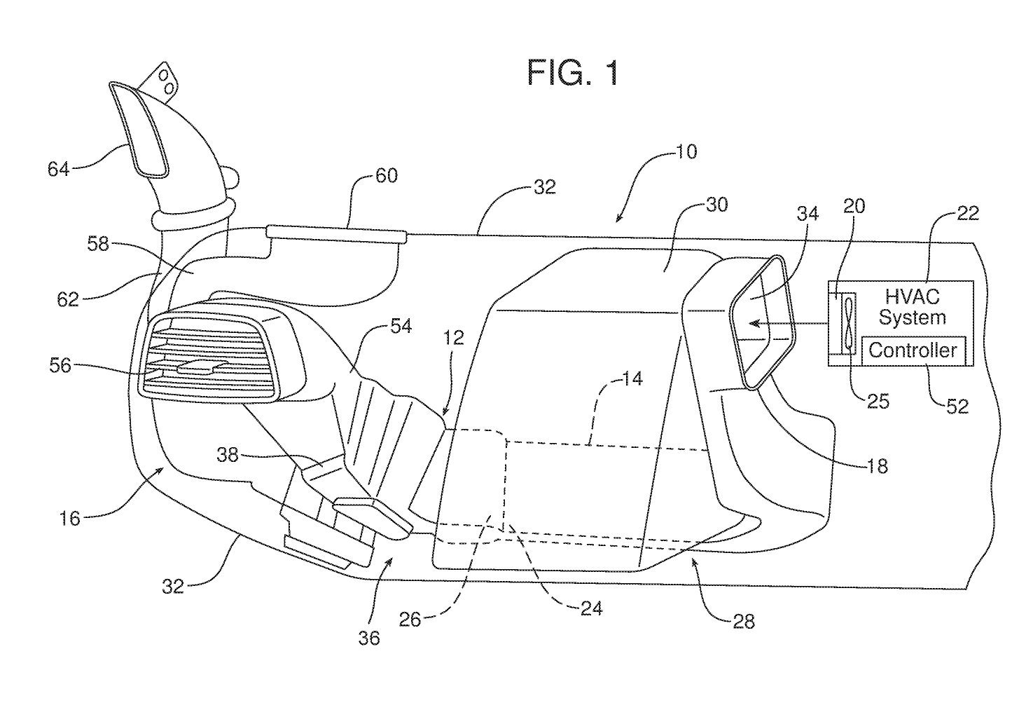

Reference is now made to FIGS. 1, 2 and 3a-3c illustrating a first embodiment of the panel and defrost plenum 10. As illustrated, the panel and defrost plenum 10 includes a manifold section 12, an air feed section 14 upstream of the manifold section and a branch section 16 downstream from the manifold section.

The air feed section 14 includes an inlet end 18 connected to the conditioned air supply manifold 20 of the HVAC system 22 and an outlet end 24 connected to the inlet port 26 of the manifold section 12. As shown in FIG. 1, the air feed section 14 functions to deliver an airstream past a HUD package restriction 28 (note HUD package 30 in the instrument panel 32 in FIG. 1) to the manifold section 12. In the illustrated embodiment, the air feed section 14 includes a single lumen 34 for receiving and directing the airstream delivered by the fan 25 of the HVAC system 22.

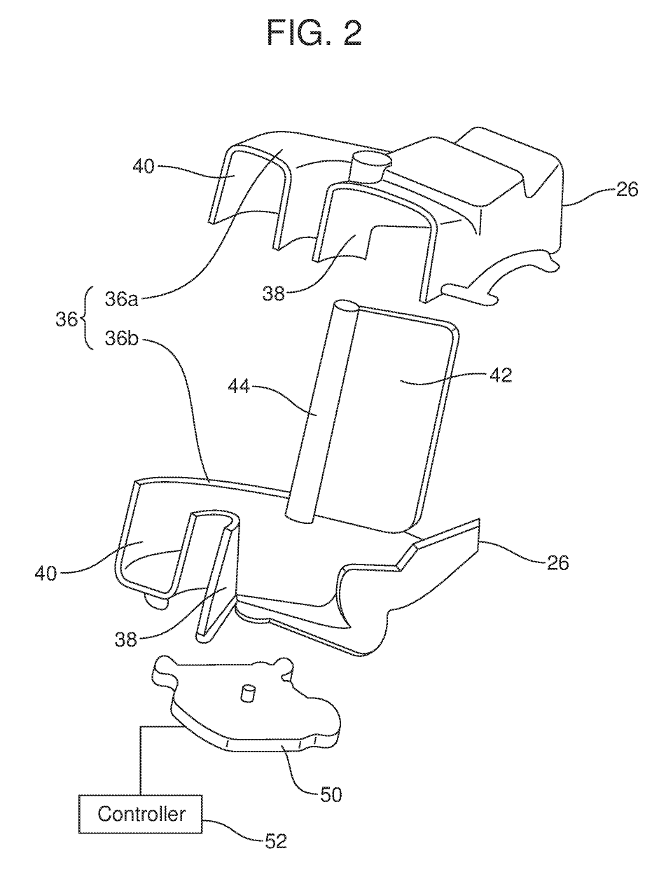

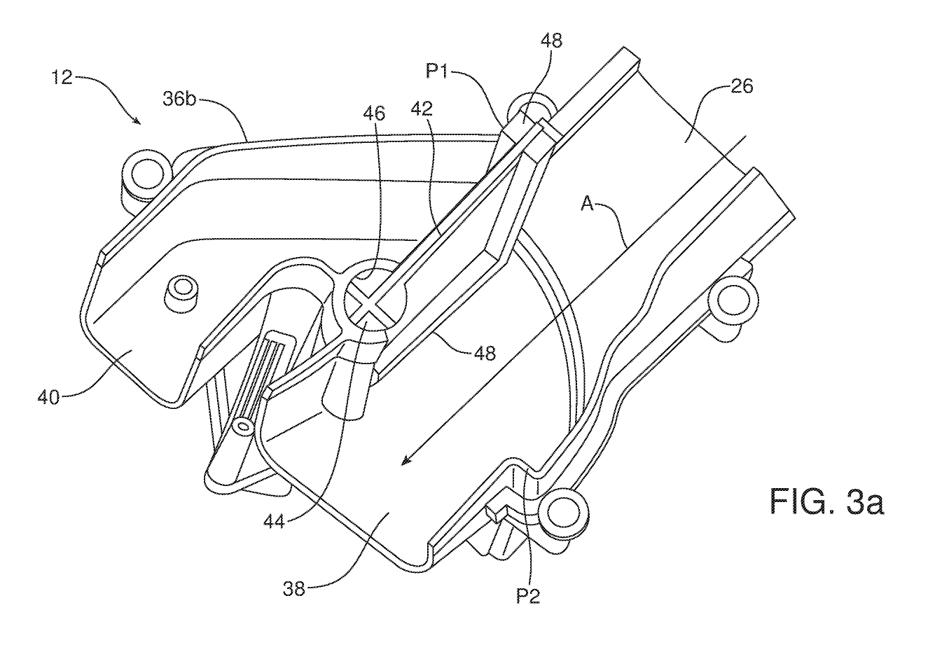

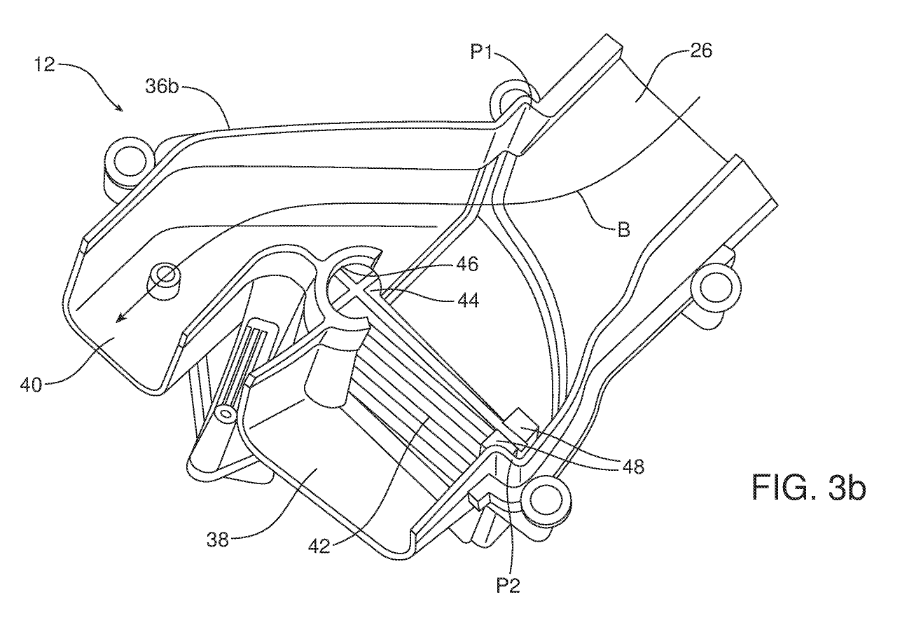

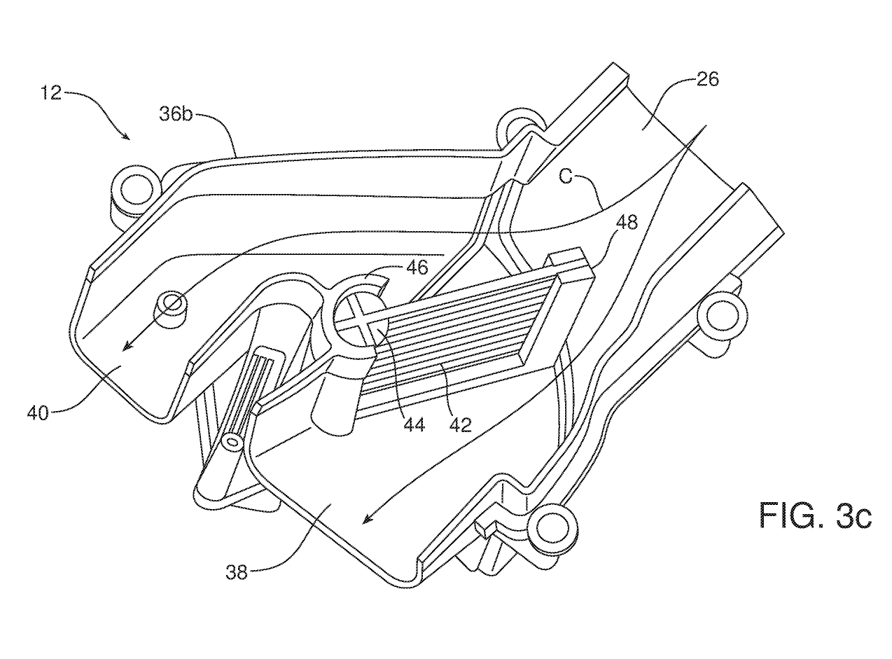

As best illustrated in FIGS. 2 and 3a-3c, the manifold section 12 includes a housing 36 (formed by two housing sections 36a, 36b) defining the inlet port 26, a first air discharge port 38 and a second air discharge port 40.

The manifold section 12 also includes a displaceable air distribution door 42 provided within the housing 36. The air distribution door 42 includes an integral pivot shaft 44 that extends along a proximal edge of the displaceable air distribution door 42 and is received in a pivot shaft receiver 46 integrally formed in the housing sections 36a, 36b. A seal 48 extends around the edge of the displaceable air distribution door 42 from one end of the pivot shaft 44 to the other.

As best illustrated in FIGS. 3a-3c, the displaceable air distribution door 42 may be selectively displaced between a number of different operating positions. FIG. 3a illustrates the displaceable air distribution door 42 in a first operating position, wherein 100% of the airstream (note action arrow A) is directed to the first air discharge port 38 and the second air discharge port 40 is sealed off by the displaceable air distribution door 42 (note door seal 48 seated against the housing section 36b at point P1.

FIG. 3b illustrates the displaceable air distribution door 42 in a second operating position wherein 100% of the airstream (note action arrow B) is directed to the second air discharge port 40 and the first air discharge port 38 is sealed off by the displaceable air distribution door (note door seal 48 engaging housing section 36b at point P2).

FIG. 3c illustrates the displaceable air distribution door in a third operating position wherein the displaceable air distribution door 42 is in an intermediate position and a first portion of the airstream is directed through the first air discharge port 38 and a second and a second portion of the airstream is directed through the second air discharge port 40 (see split action arrow C).

An actuator 50 is connected to the displaceable air distribution door 42 and functions to displace the air distribution door between the different operating positions. That actuator 50 may be controlled by the controller 52 of the HVAC system 22. Such a controller 52 is known in the art.

As illustrated in FIG. 1, the branch section 16 includes a first branch duct 54 extending from the first air discharge port 38 of the manifold section 12 to an outboard panel duct outlet 56 of a type that may be found in the front face of the instrument panel 32.

The branch section 16 also includes a second branch duct 58 extending from the second air discharge port 40 of the manifold section 12 to a windshield defrost duct outlet 60 of type that may be found in the top of the instrument panel 32 adjacent the windshield.

Still further, the branch section 16 includes a third branch duct 62 extending from the second air discharge port 40 of the manifold section 12 to a side window demist duct outlet 64 of a type that may be found, for example, in the A pillar of a motor vehicle.

Thus, it should be appreciated that when the displaceable air distribution door 42 is in the first operating position illustrated in FIG. 3a, 100% of the airstream is delivered by the panel and defrost plenum 10 to the first branch duct 54 and the outboard panel duct outlet 56. In contrast, when the displaceable air distribution door 42 is in the second operating position illustrated in FIG. 3b, 100% of the airstream is delivered through the second air discharge port to (a) the second branch duct 58 and the windshield defrost duct outlet 60 and (b) the third branch duct 62 and the side window demist duct outlet 64.

In further contrast, when the displaceable air distribution door is in the third operating position illustrated in FIG. 3c, a first portion of the airstream is delivered through the first air discharge port 38 to the first branch duct 54 and outboard panel duct outlet 56 while a second portion of the airstream is delivered through the second air discharge port 40 to the second branch duct 58 and windshield defrost duct outlet 60 and third branch duct 62 and side window demist duct outlet 64.

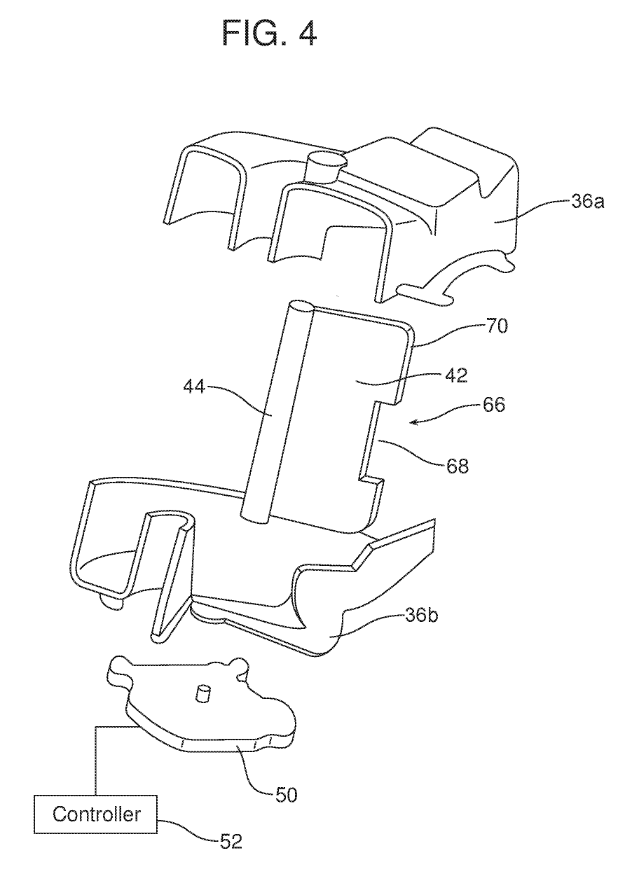

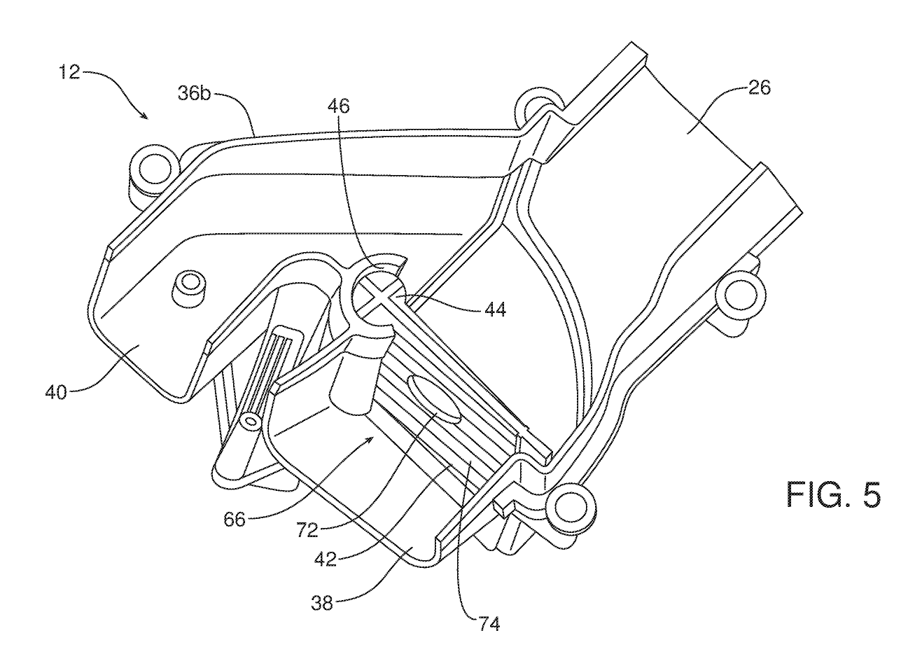

The displaceable air distribution door 42 may include an optional air bleed feature 66 if desired. In the embodiment illustrated in FIG. 4, the air bleed feature 66 comprises a notch 68 in the distal edge 70 of the displaceable air distribution door 42 opposite the pivot shaft 44. In the embodiment illustrated in FIG. 5, the air bleed feature 66 comprises an aperture 72 in the face 74 of the displaceable air distribution door 42.

As should be appreciated, in either embodiment illustrated in FIGS. 4 and 5, the air bleed feature 66 allows a small portion of the airstream to bypass the displaceable air distribution door 42 and pass through the first air discharge port 38 or second air discharge port 40 that would otherwise have been completely sealed closed by the displaceable air distribution door 42. Thus, for example, when the displaceable air distribution door 42 is in the first operating position illustrated in FIG. 3a, the air bleed feature 66 allows a small portion of the airstream to pass through the second air discharge port 40 to the second branch duct 58 and third branch duct 62. In contrast, when the displaceable air distribution door 42 is in the second operating position illustrated in FIG. 3b, the optional air bleed feature 66 allows a small portion of the airstream to pass through the first air discharge port 38 to the first branch duct 54.

Consistent with the above description, a method is provided for routing an airstream past a HUD package restriction 28. The method comprises: (a) delivering the airstream, in the air feed section 14 of the panel and defrost plenum 10 past the HUD package restriction 28 to the manifold section 12 of the panel and defrost plenum and (b) directing the airstream in the branch section 16 of the panel and defrost plenum, downstream of the manifold section, to at least one outlet, 56, 60, 64.

Toward this end, the method may include the step of providing the manifold section 12 with multiple air discharge ports 38, 40. Further, the method may include the step of diverting, by the displaceable air distribution door 42, the airstream to at least one of the air discharge ports 38, 40.

The method may also include the step of connecting the first air discharge port 38 with the outboard panel duct outlet 56. This can be done by means of the first duct 54. Further, the method may include the step of connecting the second air discharge port 40 with the windshield defrost duct outlet 60. This can be done by means of the second branch duct 58. Still further, the method may include the step of connecting the second air discharge port 40 with the side window demist duct outlet 64. This can be done by means of the third branch duct 62.

The method may also include the step of passing the airstream through the single lumen 34 of the air feed section 14 past the HUD package restriction 28. Additionally, the method may include the step of directing the airstream into the different branch ducts 54, 58, 62 on the downstream side of the HUD package restriction 28. Here, it should be noted that the manifold section 12 and the branch section 16 are located in the instrument panel 32 outboard of the HUD package restriction 28 and oriented in front of the instrument cluster, the steering wheel and the driver.

The foregoing has been presented for purposes of illustration and description. It is not intended to be exhaustive or to limit the embodiments to the precise form disclosed. Obvious modifications and variations are possible in light of the above teachings. All such modifications and variations are within the scope of the appended claims when interpreted in accordance with the breadth to which they are fairly, legally and equitably entitled.

What is claimed:

1. A panel and defrost plenum, comprising:
a manifold section;
an air feed section upstream of said manifold section, said air feed section delivering an airstream past a HUD package restriction to said manifold section; and
a branch section downstream from said manifold section.

2. The panel and defrost plenum of claim 1, wherein said manifold section includes a displaceable air distribution door.

3. The panel and defrost plenum of claim 2, further including an actuator connected to said displaceable air distribution door.

4. The panel and defrost plenum of claim 3, wherein said manifold section includes a first air discharge port and a second air discharge port.

5. The panel and defrost plenum of claim 4, wherein said branch section includes a first branch duct extending from said first air discharge port to an outboard panel duct outlet.

6. The panel and defrost plenum of claim 5, wherein said branch section includes a second branch duct extending from said second air discharge port to a windshield defrost duct outlet.

7. The panel and defrost plenum of claim 6, wherein said branch section includes a third branch duct extending from said second air discharge port to a side window demist duct outlet.

8. The panel and defrost plenum of claim 7, further including an air bleed feature on said displaceable air distribution door.

9. The panel and defrost plenum of claim 1, wherein said air feed section includes a single lumen for said airstream.

10. The panel and defrost plenum of claim 2, wherein said displaceable air distribution door includes a pivot axis.

11. The panel and defrost plenum of claim 10, further including an air bleed feature in an edge of said displaceable air distribution door opposite said pivot axis.

12. A method of routing an airstream past a HUD package restriction, comprising:
delivering said airstream, in an air feed section of a plenum past said HUD package restriction to a manifold section of the plenum; and
directing said airstream in a branch section of said plenum, downstream of said manifold section, to at least one outlet.

13. The method of claim 12, including providing said manifold section with multiple air discharge ports and diverting, by displaceable air distribution door, said airstream to at least one of said air discharge ports.

14. The method of claim 13, including connecting a first air discharge port of said multiple air discharge ports with an outboard panel duct outlet.

15. The method of claim 14, including connecting a second air discharge port of said multiple air discharge ports with a windshield defrost duct outlet.

16. The method of claim 15, including connecting said second air discharge port of said multiple air discharge ports with a side window demist duct outlet.

17. The method of claim 12, including passing said airstream through a single lumen past said HUD package restriction.

18. The method of claim 17, including directing said airstream into different branch ducts on a downstream side of said HUD package restriction.
